(19) United States
(12) Patent Application Publication
(10) Pub. No.: US 2016/0224759 A1
(43) Pub. Date: Aug. 4, 2016

(54) PURCHASING INTERFACE

(71) Applicant: 1-800 Contacts, Inc., Draper, UT (US)

(72) Inventors: Justin Douglas Olson, Salt Lake City, UT (US); Antoine Marc Fraikin, American Fork, UT (US); Kevin Matthew Jensen, Lehi, UT (US); Brent Daniel Jensen, Bluffdale, UT (US)

(73) Assignee: 1-800 Contacts, Inc., Draper, UT (US)

(21) Appl. No.: 14/614,312

(22) Filed: Feb. 4, 2015

(51) Int. Cl. G06F 19/00

(52) U.S. Cl. CPC G06F 19/3456

(57) ABSTRACT

A method for a purchasing interface is described. In one embodiment, the method includes initiating an order for a prescription, prompting a user to capture a photo of the prescription, and fulfilling the order for the prescription upon receiving input based on capturing the photo of the prescription. The order for the prescription is initiated from an application executing on a computing device and the photo of the prescription is captured using a camera connected to the computing device.

### BACKGROUND

Advancements in media delivery systems and data-related technologies continue to increase at a rapid pace. Increasing demand for accessible data has influenced the advances made to data-related technologies. Computer systems have increasingly become an integral part of data creation, data usage, and data storage. Computer systems may be used to carry out several data-related functions. The wide-spread access to data has been accelerated by the increased use of computer networks, including the Internet and cloud networking.

Many homes and businesses use one or more computer networks to generate, deliver, and receive data and information between the various computers connected to computer networks. Users of computer technologies continue to demand increased access to information and an increase in the efficiency of these technologies. Improving the efficiency of computer technologies is desirable to those who use and rely on computers.

With the wide-spread use of computers and mobile devices has come an increased presence of and continued advancements in mobile phone applications and commerce. For example, advancements in mobile devices allow users to purchase products from anywhere in the world. Nevertheless, benefits may be realized by providing systems and methods for improving commerce systems.

### SUMMARY

According to at least one embodiment, a method for a purchase interface is described. In one embodiment, the method may include initiating an order for a prescription, prompting a user to capture a photo of the prescription, and fulfilling the order for the prescription upon receiving input based on capturing the photo of the prescription. The order for the prescription may be initiated from an application executing on a computing device and the photo of the prescription may be captured using a camera connected to the computing device.

In some embodiments, the method may include capturing the photo of the prescription and prompting the user to accept or reject the captured photo of the prescription. Upon determining the user rejects the captured photo of the prescription, the user may be prompted to take another photo of the prescription.

In some embodiments, the method may include querying the user to choose whether to take an additional photo of the prescription. Upon receiving a request to take an additional photo of the prescription, the method may include capturing an additional photo of the prescription. Upon determining the user accepts the captured photo of the prescription, the method may include prompting the user for a quantity of the order for the prescription. Upon determining the user's payment information is not received, the method may include prompting the user for payment information.

In some embodiments, upon receiving the captured photo of the prescription and the quantity of the order, the method may include displaying a confirmation page to the user. The confirmation page may display the captured photo of the prescription and/or indicate the quantity of the order selected by the user. In some cases, the confirmation page may display payment information.

In some embodiments, the method may include sending order information to a customer agent. The order information may include at least one captured photo of the prescription and the quantity of the order. In some cases, the method may include fulfilling the order for the prescription upon receiving input from the customer agent. The input from the customer agent may be based, at least in part, on at least one captured photo of the prescription.

A computing device configured for a purchase interface is also described. The computing device may include a processor and memory in electronic communication with the processor. The memory may store computer executable instructions that when executed by the processor cause the processor to perform the steps of initiating an order for a prescription, prompting a user to capture a photo of the prescription, fulfilling the order for the prescription upon receiving input based on capturing the photo of the prescription. The order for the prescription may be initiated from an application executing on a computing device and the photo of the prescription may be captured using a camera connected to the computing device.

A non-transitory computer-readable storage medium storing computer executable instructions is also described. When the instructions are executed by a processor, the execution of the instructions may cause the processor to perform the steps of initiating an order for a prescription, prompting a user to capture a photo of the prescription, fulfilling the order for the prescription upon receiving input based on capturing the photo of the prescription. The order for the prescription may be initiated from an application executing on a computing device and the photo of the prescription may be captured using a camera connected to the computing device.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram illustrating one embodiment of an environment in which the present systems and methods may be implemented;

FIG. 2 is a block diagram illustrating one example of a purchasing module;

FIG. 3 is a block diagram illustrating one example of an environment for a purchase interface;

FIG. 4 is a flow diagram illustrating one embodiment of a method for a purchase interface;

FIG. 5 is a flow diagram illustrating one embodiment of a method for a purchase interface; and

FIG. 6 depicts a block diagram of a computer system suitable for implementing the present systems and methods.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

The systems and methods described herein relate to a prescription purchasing interface. More specifically, the systems and methods described herein relate to a purchase interface in relation to prescription refill system. Some embodiments of the systems and methods described herein relate to a purchase interface in relation to an application executing on a computing device. The application may include a mobile application executing on a mobile device (e.g., an APPLE® mobile app executing on an IPHONE®, etc.). In some cases, the application may include a desktop application running on a desktop and/or laptop. In some embodiments, the application may include a web application executing on a browser. The computing device may include a desktop, laptop, tablet, smart phone, etc.

Users of prescription websites, mobile applications, and services may worry that the information that they enter may not be entered correctly, resulting in the hassle of dealing with an incorrect order, including purchasing return postage, purchasing postage insurance, taking the package to the post office, and not knowing whether the package will be lost or damaged on the return shipment. Currently, a user may have to contact his or her doctor and request that the doctor send a valid prescription before the prescription can be filled, resulting in additional inconvenience to the user and additional delays before receiving the prescription.

In one example, a user captures an image of a prescription using the camera on his or her mobile computing device. The system then prompts the user to enter a quantity. The system may prompt the user for payment information. In some cases, the system may prompt the user for shipping information. The system may send the captured photo and quantity to a customer agent. The system may enable the customer agent to complete the order by entering information relative to the captured photo.

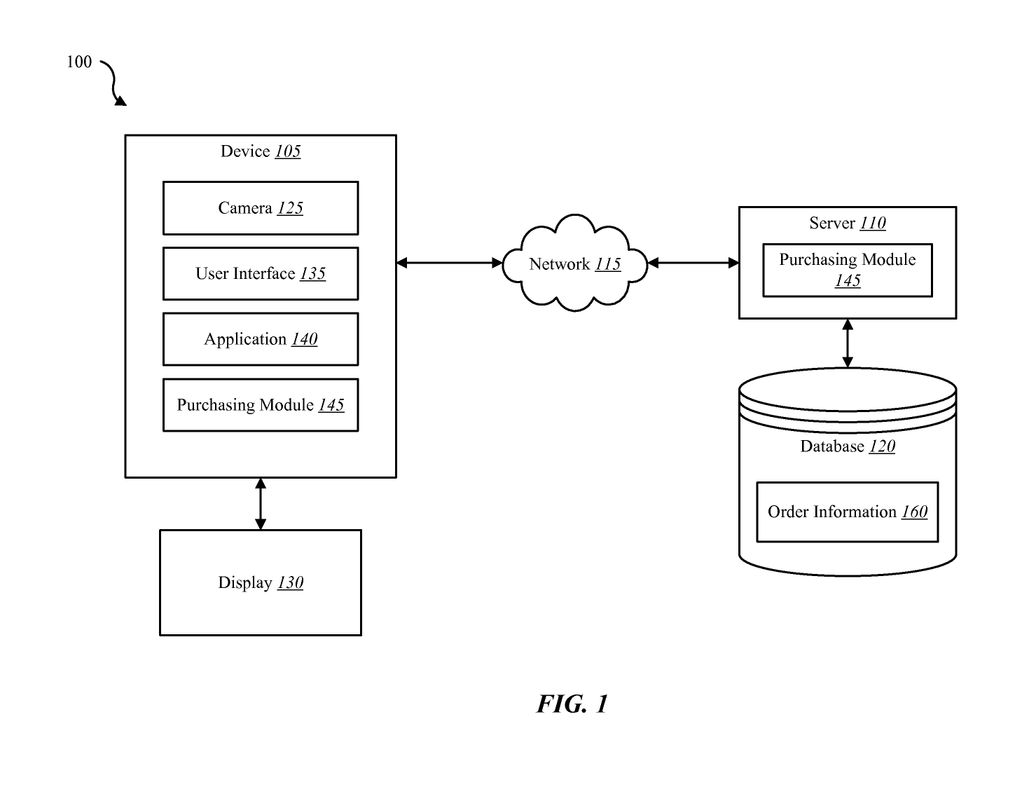

FIG. 1 is a block diagram illustrating one embodiment of an environment 100 in which the present systems and methods may be implemented. In some embodiments, the systems and methods described herein may be performed on a device (e.g., device 105). As depicted, the environment 100 may include a device 105, server 110, a display 130, and a network 115 that allows the device 105 and the server 110 to communicate with one another.

Examples of the device 105 may include any combination of mobile devices, smart phones, personal computing devices, computers, laptops, desktops, servers, etc. Examples of server 110 may include any combination of a data server, a cloud server, a server associated with an automation service provider, proxy server, mail server, web server, application server, database server, communications server, file server, home server, mobile server, name server, etc.

In some configurations, the device 105 may include a camera 125, a user interface 135, application 140, and purchasing module 145. Although the components of the device 105 are depicted as being internal to the device 105, it is understood that one or more of the components may be external to the device 105 and connect to device 105 through wired and/or wireless connections. For example, camera 125 may be connected to device 105 by wire and/or wirelessly. In some embodiments, device 105 may include an internal and/or external microphone. In some embodiments, application 140 may be installed on computing device 105 in order to allow a user to interface with a function of server 110.

In some embodiments, device 105 may communicate with server 110 via network 115. Examples of network 115 may include any combination of cloud networks, local area networks (LAN), wide area networks (WAN), virtual private networks (VPN), wireless networks (using 802.11, for example), cellular networks (using 3G and/or LTE, for example), etc. In some configurations, the network 115 may include the Internet. It is noted that in some embodiments, the device 105 may not include a purchasing module 145. For example, device 105 may include application 140 that allows device 105 to interface with purchasing module 145 located on another device such as server 110. In some embodiments, device 105, automation controller 155, and server 110 may include a purchasing module 145 where at least a portion of the functions of purchasing module 145 are performed separately and/or concurrently on device 105, automation controller 155, and/or server 110. Likewise, in some embodiments, a user may access the functions of device 105 and/or automation controller 155 (directly or through device 105 via purchasing module 145) from computing device 150. For example, in some embodiments, computing device 150 includes a mobile application that interfaces with one or more functions of device 105, automation controller 155, purchasing module 145, and/or server 110.

In some embodiments, server 110 may be coupled to database 120. Database 120 may be internal or external to the server 110. In one example, device 105 may be coupled directly to database 120, database 120 being internal or external to device 105. Database 120 may include order information 160. For example, device 105 may access order information 160 in database 120 over network 115 via server 110. In some cases, at least a portion of order information 160 may be present on memory or a storage device of device 105. In some cases, at least a portion of order information 160 may be generated on device 105. Order information 160 may include data regarding a prescription, a captured image of a prescription, order quantity, brand information, payment information, user information, user confirmation, and the like.

Purchasing module 145 may enable a prescription fulfillment center to provide customers a timely and error-free system to order prescriptions. Many customers do not like the inconvenience of entering the information from their prescription to an online system. Moreover, the labels used on a prescription may not match the information on the ordering website. For example, although they mean the same thing, one prescription may prescribe a value for “Power” while another prescription may prescribe a value for “Sphere.” Also, the prescription may refer to the abbreviations OD (oculus dexter) instead of “right eye,” OS (oculus sinister) instead of “left eye,” or OU (oculus uterque) instead of “both eyes,” further adding to customer confusion. Furthermore, a customer may be more likely to make a mistake when entering prescription information from a mobile or handheld computer. The system and methods described herein, however, remove the inconvenience and apprehension a user experiences while using current systems for ordering prescriptions. Accordingly, in some embodiments, purchasing module 145 may be configured to perform the systems and methods described herein in conjunction with user interface 135 and application 140 to improve the customer experience in ordering prescriptions. Further details regarding the purchasing module 145 are discussed below.

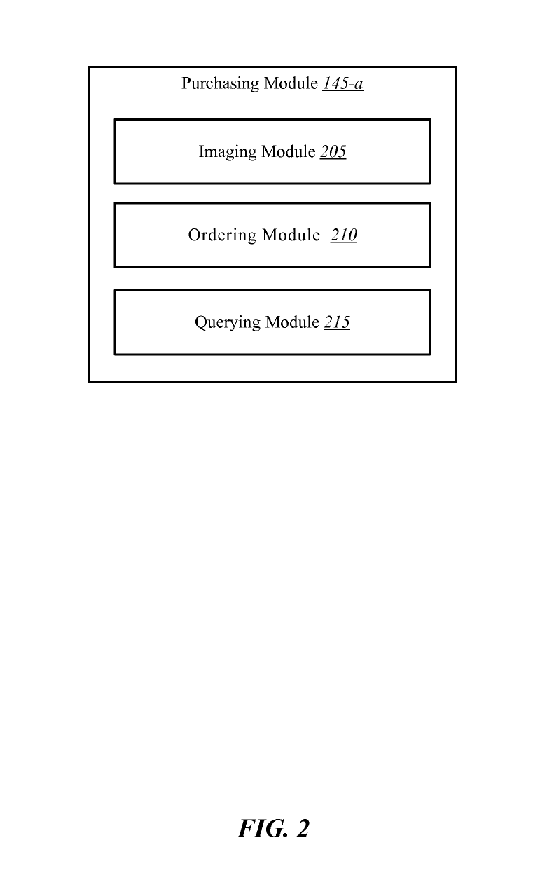

FIG. 2 is a block diagram illustrating one example of a purchasing module 145-a. Purchasing module 145-a may be one example of purchasing module 145 depicted in FIG. 1. As depicted, purchasing module 145-a may include imaging module 205, ordering module 210, and querying module 215.

In one embodiment, purchasing module 145 may initiate an order for a prescription. The order for the prescription may be initiated from an application on a computing device. For example, a user may execute a mobile application configured to fill prescriptions online. The mobile application may prompt the user to capture an image of a prescription and fill a prescription based on the captured image. In some cases, the order may initiate via a browser running on a computing device (e.g., CHROME®, SAFARI®, INTERNET EXPLORER®, etc.). For example, a user on a desktop, laptop, or mobile device may browse to a website that enables the user to capture an image of the prescription via a camera attached to the computing device and accessible to the browser. In some cases, the prescription may be filled in conjunction with web application. Thus, a user may fill a prescription using a browser and/or web application.

In some embodiments, imaging module 205 may prompt a user to capture a photo of the prescription. The photo of the prescription may be captured using a camera on the mobile computing device (e.g., via camera 125 of FIG. 1). In some cases, ordering module 210 may fulfill the order for the prescription upon receiving input based on capturing the photo of the prescription. In some cases, upon receiving an input from the user, imaging module 205 may capture the photo of the prescription.

In one embodiment, querying module 215 may prompt the user to accept or reject the captured photo of the prescription. Upon determining the user rejects the captured photo of the prescription, imaging module 205 may prompt the user to take another photo of the prescription. For example, querying module 215 may prompt the user to accept or reject the captured photo of the prescription on a display of the mobile computing device (e.g., display 130 of device 105). A user interface (e.g., user interface 135) may display an accept button and a reject button. If the user presses the accept button, then the captured image may be kept. If the user presses the reject button, then the captured image may be deleted. The querying module 215 may then prompt the user whether to capture another photo of the prescription.

In some embodiments, upon determining the user accepts a captured photo, querying module 215 may query the user to choose whether to take an additional photo of the prescription. Some prescriptions may be printed on a relatively large piece of paper. The user may capture a portion of the prescription with a first captured photo and capture another portion of the prescription with a second captured photo, and so forth. In some cases, the prescription may include two sides. Thus, the user may capture a first side with a first captured photo and a second side of the prescription with a second photo. In some embodiments, upon receiving a request to take an additional photo of the prescription, imaging module 205 may capture an additional photo of the prescription.

In one embodiment, upon determining the user accepts the captured photo of the prescription, querying module 215 may prompt the user for a quantity of the order for the prescription. The purchasing module 145 may enable the user to select a quantity by entering a number and/or by scrolling through a quantity selection tool. In some cases, upon determining the user's payment information is not received (e.g., not previously given and/or not previously stored), querying module 215 may prompt the user for payment information.

In one embodiment, upon receiving the captured photo of the prescription and the quantity of the order, ordering module 210 may display a confirmation page to the user. In some cases, the confirmation page may display the captured photo of the prescription, indicate the quantity and/or other attributes like color of the order selected by the user, etc. In some cases, the confirmation page may indicate payment information.

In one embodiment, ordering module 210 may send order information to a customer agent. For example, ordering module 210 may send order information from device 105 to server 110 via network 115. The customer agent may receive the ordering information via server 110. The order information may include at least one captured photo of the prescription and the quantity of the order. Upon receiving a confirmation from the customer based on the user input received in response to display of the confirmation page, the ordering module 210 may send the order information to the customer agent.

Ordering module 210 may fulfill the order for the prescription upon receiving input from the customer agent. The input from the customer agent may be based on at least one captured photo of the prescription and the quantity of the order selected by the user. For example, the customer agent may enter information regarding a prescription that is contained in a captured image of the prescription. For example, the prescription may be written for a pair of optical contact lenses. The prescription may include one or more attributes associated with a contact lens prescription. Accordingly, the customer agent may receive a captured image of the prescription and transcribe one or more attributes contained in the photo of the prescription into the prescription order of the user. Based on the captured image, the order quantity selected by the user, the information entered by the customer agent based on the captured image, and the payment information, the user's order may be filled.

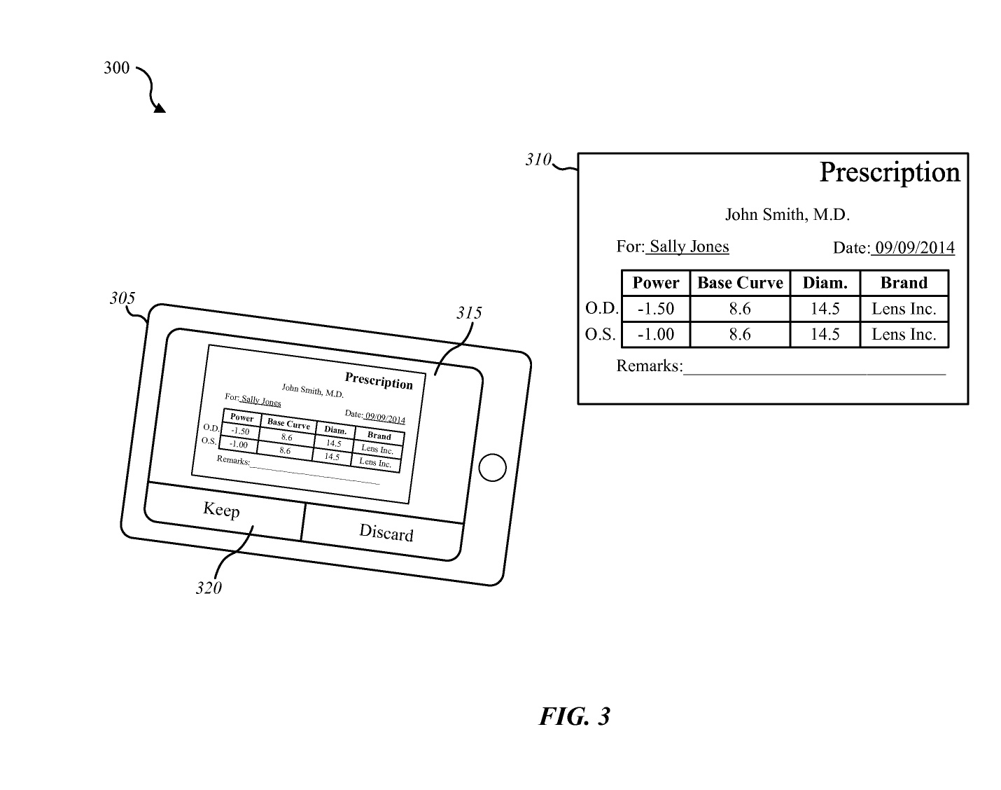

FIG. 3 is a block diagram illustrating one example of an environment 300 for a purchase interface. As depicted, the environment 300 may include a mobile device 305 and a prescription 310. Although prescription 310 depicts an example prescription for contact lenses, it is understood that other types of prescriptions may be filled using the present systems and methods. The mobile device 305 may be one example of device 105 from FIG. 1. As illustrated, mobile device 305 may include a display 315. Display 315 may be one example of display 130 from FIG. 1.

In one embodiment, a user may open a mobile application available on mobile device 305. The mobile application may function in conjunction with purchasing module 145. The mobile application may prompt the user to capture a photo of a prescription. As depicted, display 315 shows a captured image of prescription 310. Display 315 also shows an element of a user interface 320 (e.g., user interface 135 from FIG. 1). The user interface 320 depicts a prompt for a user to either “keep” or to “discard” the captured image of prescription 310. Upon selecting “keep,” the user interface 320 may prompt the user to take another photo or to continue. Upon selecting “discard,” the user interface may prompt the user to take another photo to replace the discarded one. Upon capturing at least one photo of the prescription 310, the user interface 320 may prompt the user to enter a quantity for the prescription. Additionally, or alternatively, user interface 320 may prompt the user to enter payment information. In some cases, user interface 320 may prompt the user to enter a brand name for the prescription. As depicted, prescription 310 includes a brand (e.g., “Lens Inc.”). However, user interface 320 may enable the user to select a different brand and/or confirm the brand specified on a prescription. Upon receiving input from the user, including at least one captured image of prescription 310, the mobile application may send this user input to a customer agent. The customer agent may be enabled to fulfill the order by processing the user input (e.g., order quantity and/or payment information) and entering one or more aspects from the captured image of prescription 310. For example, based on the example prescription 310, the customer agent may enter a value for “power” of “−1.50” for the right eye and “−1.00” for the left eye, as well as a base curve of 8.6 and diameter of 14.5 for both eyes. With the information input from the user and the information input from the customer agent, the customer agent may be enabled to complete the order. Accordingly, when the user has previously provided payment information and this payment information is stored by the purchasing module 145, the present systems and methods may enable the user to complete a prescription by simply providing a captured image and order quantity and submitting this information to a customer agent.

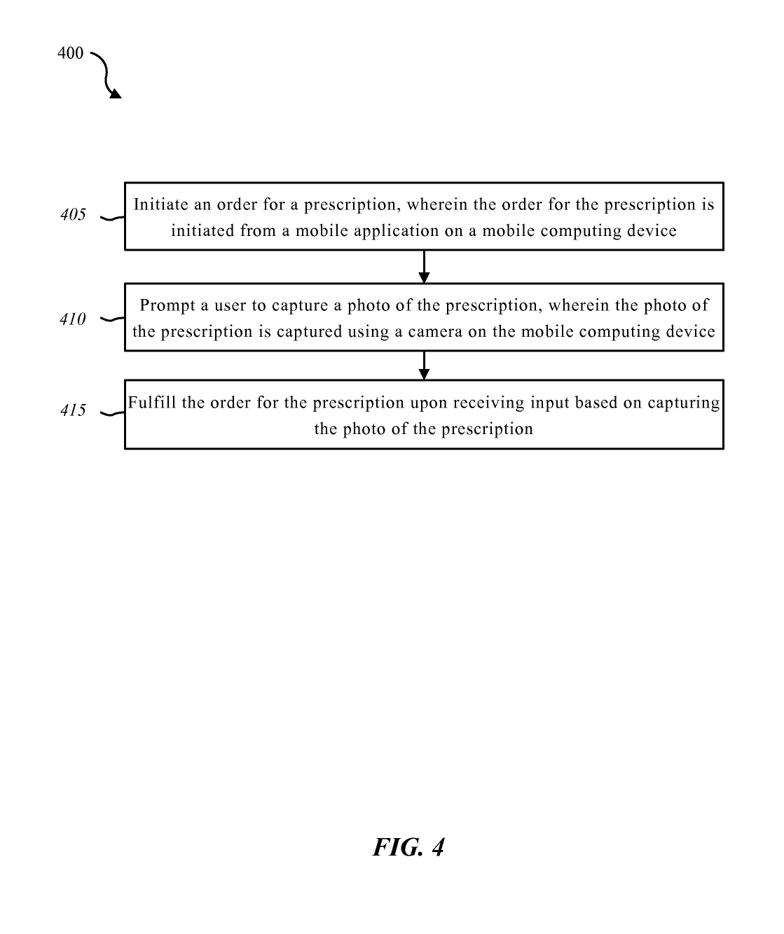

FIG. 4 is a flow diagram illustrating one embodiment of a method 400 for a purchase interface. In some configurations, the method 400 may be implemented by the purchasing module 145 illustrated in FIGS. 1 and/or 2. In some configurations, the method 400 may be implemented in conjunction with the application 140 and/or the user interface 135 illustrated in FIG. 1.

At block 405, an order for a prescription may be initiated. The order for the prescription may be initiated from an application executing on a computing device. At block 410, a user may be prompted to capture a photo of the prescription. The photo of the prescription may be captured using a camera connected to the computing device. At block 415, the order for the prescription may be fulfilled upon receiving input based on capturing the photo of the prescription

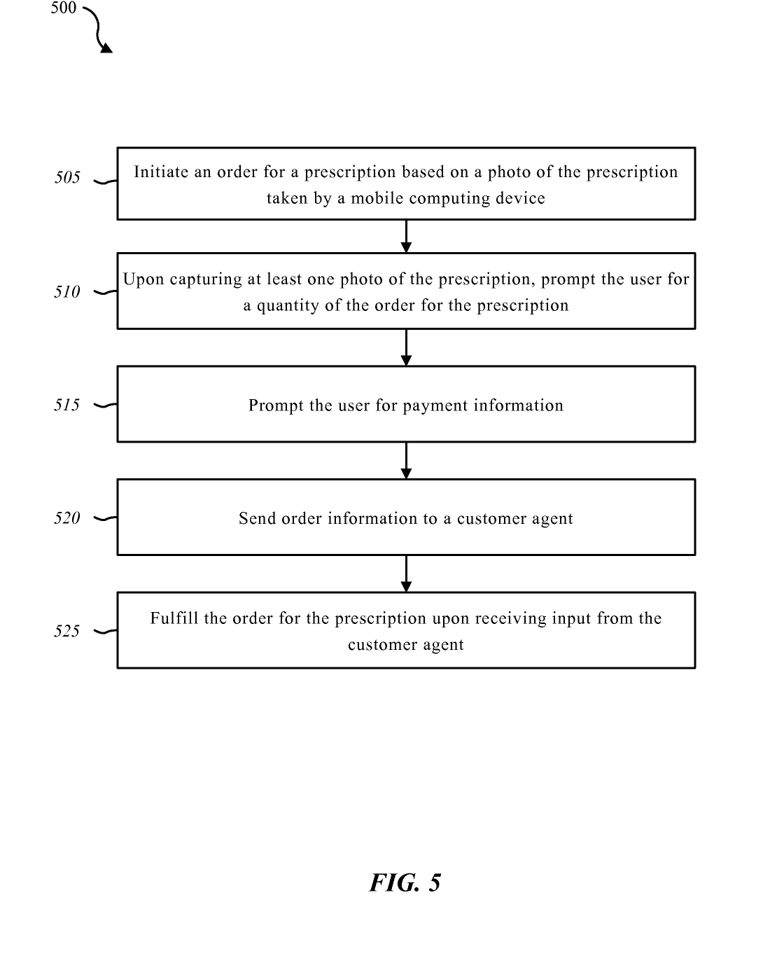

FIG. 5 is a flow diagram illustrating one embodiment of a method 500 for a purchase interface. In some configurations, the method 500 may be implemented by the purchasing module 145 illustrated in FIG. 1 or 2. In some configurations, the method 500 may be implemented in conjunction with the application 140 and/or the user interface 135 illustrated in FIG. 1.

At block 505, an order for a prescription may be initiated based on a photo of the prescription taken by a camera of a computing device. At block 510, upon capturing at least one photo of the prescription, the user may be prompted for a quantity of the order for the prescription. At block 515, upon receiving the quantity for the order, the user may be prompted for payment information. In some embodiments, the user may be prompted to provide shipping information. In some cases, the user may be prompted and/or enabled to provide information regarding a prescription such as a quantity, a brand, a product or model of a brand, a requested shipment arrival date, a user's preference such as color preference for colored contact lens, etc.

At block 520, order information may be sent to a customer agent. The order information may include at least one captured photo of the prescription and the quantity of the order. In some cases, a confirmation page may be displayed. The user may provide a confirmation in response to the display of the confirmation page. Upon receiving the confirmation from the user, the order information may be sent to the customer agent. At block 525, the order for the prescription may be fulfilled upon receiving input from the customer agent. The input from the customer agent may be based, at least in part, on at least one captured photo of the prescription.

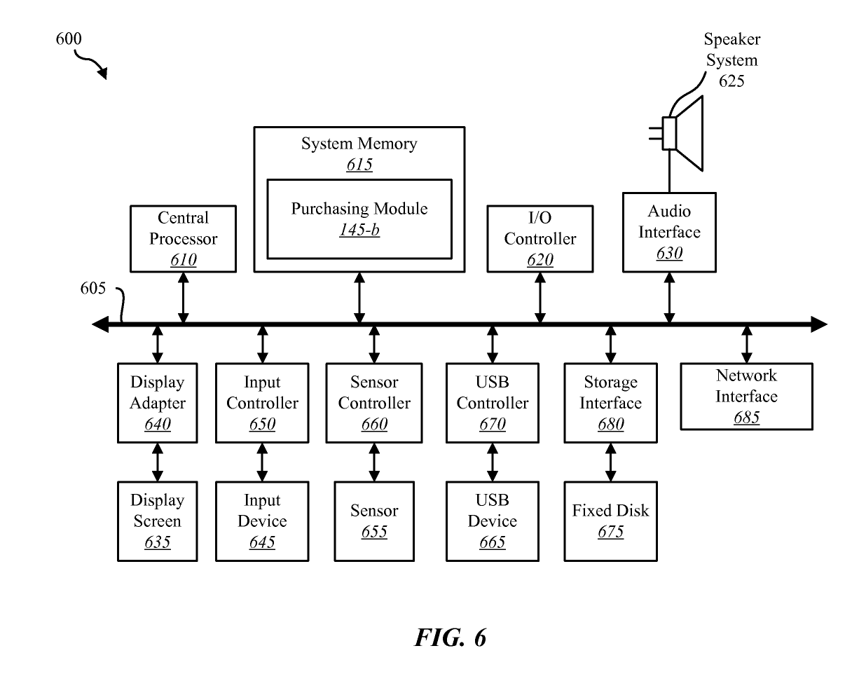

FIG. 6 depicts a block diagram of a computing device 600 suitable for implementing the present systems and methods. The device 600 may be an example of device 105, computing device 150 and/or server 110 illustrated in FIG. 1. In one configuration, device 600 includes a bus 605 which interconnects major subsystems of device 600, such as a central processor 610, a system memory 615 (typically RAM, but which may also include ROM, flash RAM, or the like), an input/output controller 620, an external audio device, such as a speaker system 625 via an audio output interface 630. In some embodiments, audio interface 630 may include a microphone. In some cases, device 600 may include an external device, such as a display screen 635 via display adapter 640, an input device 645 (e.g., remote control device interfaced with an input controller 650), multiple USB devices 665 (interfaced with a USB controller 670), and a storage interface 680. In some cases, input device 645 may include a camera. Also included are at least one sensor 655 connected to bus 605 through a sensor controller 660 and a network interface 685 (coupled directly to bus 605). In some embodiments, sensor 655 may include a camera sensor and/or microphone sensor.

Bus 605 allows data communication between central processor 610 and system memory 615, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components or devices. For example, the purchasing module 145-b to implement the present systems and methods may be stored within the system memory 615. Applications (e.g., application 140) resident with device 600 are generally stored on and accessed via a non-transitory computer readable medium, such as a hard disk drive (e.g., fixed disk 675) or other storage medium. Additionally, applications can be in the form of electronic signals modulated in accordance with the application and data communication technology when accessed via interface 685.

Storage interface 680, as with the other storage interfaces of device 600, can connect to a standard computer readable medium for storage and/or retrieval of information, such as a fixed disk drive 675. Fixed disk drive 675 may be a part of device 600 or may be separate and accessed through other interface systems. Network interface 685 may provide a direct connection to a remote server via a direct network link to the Internet via a POP (point of presence). Network interface 685 may provide such connection using wireless techniques, including digital cellular telephone connection, Cellular Digital Packet Data (CDPD) connection, digital satellite data connection, or the like. In some embodiments, one or more sensors (e.g., motion sensor, smoke sensor, glass break sensor, door sensor, window sensor, carbon monoxide sensor, and the like) connect to device 600 wirelessly via network interface 685.

Many other devices or subsystems (not shown) may be connected in a similar manner (e.g., entertainment system, computing device, remote cameras, wireless key fob, wall mounted user interface device, cell radio module, battery, alarm siren, door lock, lighting system, thermostat, home appliance monitor, utility equipment monitor, and so on). Conversely, all of the devices shown in FIG. 6 need not be present to practice the present systems and methods. The devices and subsystems can be interconnected in different ways from that shown in FIG. 6. The aspect of some operations of a system such as that shown in FIG. 6 are readily known in the art and are not discussed in detail in this application. Code to implement the present disclosure can be stored in a non-transitory computer-readable medium such as one or more of system memory 615 or fixed disk 675. The operating system provided on device 600 may be iOS®, ANDROID®, MS-DOS®, MS-WINDOWS®, OS/2®, UNIX®, LINUX®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present systems and methods may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.” In addition, the term “based on” as used in the specification and the claims is to be construed as meaning “based at least upon.”

What is claimed is:

1. A method for a purchasing interface, comprising:
initiating an order for a prescription, wherein the order for the prescription is initiated from an application executing on a computing device;
prompting a user to capture a photo of the prescription, wherein the photo of the prescription is captured using a camera connected to the computing device; and
fulfilling the order for the prescription upon receiving input based on capturing the photo of the prescription.

2. The method of claim 1, further comprising:
capturing the photo of the prescription; and
prompting the user to accept or reject the captured photo of the prescription.

3. The method of claim 2, further comprising:
upon determining the user rejects the captured photo of the prescription, prompting the user to take another photo of the prescription.

4. The method of claim 2, further comprising:
upon determining the user accepts the captured photo of the prescription, prompting the user for a quantity of the order for the prescription.

5. The method of claim 1, further comprising:
querying the user to choose whether to take an additional photo of the prescription.

6. The method of claim 1, further comprising:
upon receiving a request to take an additional photo of the prescription, capturing the additional photo of the prescription.

7. The method of claim 1, further comprising:
upon determining the user's payment information is not received, prompting the user for the payment information.

8. The method of claim 1, further comprising:
upon receiving the captured photo of the prescription and a quantity of the order, displaying a confirmation page to the user, the confirmation page displaying the captured photo of the prescription and indicating the quantity of the order selected by the user.

9. The method of claim 1, further comprising:
sending order information to a customer agent, the order information comprising at least one captured photo of the prescription and a quantity of the order.

10. The method of claim 1, further comprising:
fulfilling the order for the prescription upon receiving input from a customer agent, the input from the customer agent being based, at least in part, on at least one captured photo of the prescription.

11. A computing device configured for a purchasing interface, comprising:
a processor;
memory in electronic communication with the processor, wherein the memory stores computer executable instructions that when executed by the processor cause the processor to perform the steps of:
initiating an order for a prescription, wherein the order for the prescription is initiated from an application executing on a computing device;
prompting a user to capture a photo of the prescription, wherein the photo of the prescription is captured using a camera connected to the computing device; and
fulfilling the order for the prescription upon receiving input based on capturing the photo of the prescription.

12. The computing device of claim 11, wherein the instructions executed by the processor cause the processor to perform the steps of:
capturing the photo of the prescription; and
prompting the user to accept or reject the captured photo of the prescription.

13. The computing device of claim 12, wherein the instructions executed by the processor cause the processor to perform the steps of:
upon determining the user rejects the captured photo of the prescription, prompting the user to take another photo of the prescription.

14. The computing device of claim 12, wherein the instructions executed by the processor cause the processor to perform the steps of:
upon determining the user accepts the captured photo of the prescription, prompting the user for a quantity of the order for the prescription.

15. The computing device of claim 11, wherein the instructions executed by the processor cause the processor to perform the steps of:
querying the user to choose whether to take an additional photo of the prescription.

16. The computing device of claim 11, wherein the instructions executed by the processor cause the processor to perform the steps of:
upon receiving a request to take an additional photo of the prescription, capturing the additional photo of the prescription.

17. The computing device of claim 11, wherein the instructions executed by the processor cause the processor to perform the steps of:
upon determining the user's payment information is not received, prompting the user for the payment information.

18. The computing device of claim 11, wherein the instructions executed by the processor cause the processor to perform the steps of:
sending order information to a customer agent, the order information comprising at least one captured photo of the prescription and a quantity of the order; and
fulfilling the order for the prescription upon receiving input from the customer agent, the input from the customer agent being based, at least in part, on the at least one captured photo of the prescription.

19. A non-transitory computer-readable storage medium storing computer executable instructions that when executed by a processor cause the processor to perform the steps of:
initiating an order for a prescription, wherein the order for the prescription is initiated from an application executing on a computing device;
prompting a user to capture a photo of the prescription, wherein the photo of the prescription is captured using a camera connected to the computing device; and
fulfilling the order for the prescription upon receiving input based on capturing the photo of the prescription.

20. The computer-program product of claim 19, wherein the instructions executed by the processor cause the processor to perform the steps of:
capturing the photo of the prescription; and
prompting the user to accept or reject the captured photo of the prescription.
